(19) United States
(12) Patent Application Publication
(10) Pub. No.: US 2024/0210165 A1
(43) Pub. Date: Jun. 27, 2024

(54) STRAIN MEASURING DEVICE

(71) Applicant: SAMSUNG ELECTRONICS CO., LTD., SUWON-SI (KR)

(72) Inventors: Jauk GU, Suwon-si (KR); Ilbum KWON, Daejeon (KR); Yongseok KWON, Daejeon (KR); Gunhyeong KIM, Suwon-si (KR); Yongwoon JUNG, Suwon-si (KR)

(73) Assignee: Korea Research Institute Of Standards And Science, Daejeon (KR)

(21) Appl. No.: 18/537,903

(22) Filed: Dec. 13, 2023

(30) Foreign Application Priority Data
Dec. 21, 2022 (KR) 10-2022-0181073

(51) Int. Cl. G01B 11/16

(52) U.S. Cl. CPC G01B 11/16

(57) ABSTRACT

A strain measuring device includes a first sensing optical fiber disposed on a surface of a measurement target. A second sensing optical fiber is spaced apart from the first sensing optical fiber and arranged parallel to the first sensing optical fiber. The second sensing optical fiber is spaced apart from the surface of the measurement target. An optical fiber guide has an inner cavity. The optical fiber guide is bonded to the surface of the measurement target to be positioned on the surface of the measurement target. The second sensing optical fiber is disposed in the inner cavity. A controller receives measured values from the first sensing optical fiber and the second sensing optical fiber. The first sensing optical fiber and the second sensing optical fiber include optical fibers for measuring strain.

### CROSS-REFERENCE TO RELATED APPLICATION

This application claims priority under 35 U.S.C. § 119 to Korean Patent Application No. 10-2022-0181073, filed on Dec. 21, 2022, in the Korean Intellectual Property Office, the disclosure of which is incorporated by reference in its entirety herein.

### 1. TECHNICAL FIELD

The present inventive concept relates to a strain measuring device, and more particularly, to a strain measuring device including optical fibers.

### 2. DISCUSSION OF RELATED ART

When measuring the strain of a target object using optical fibers, strain that changes according to the external environment of the target object is included in the strain of the target object. For example, the measured strain may include strain due to the temperature of the target object which results in thermal expansion or thermal contraction of the target object. Therefore, the accuracy of the measured strain of the target object may be reduced.

### SUMMARY

Embodiments of the present inventive concept provides a strain measuring device for measuring the pure strain excluding the change due to temperature when measuring the strain of a measurement target through sensing optical fibers.

An aspect of the inventive concept is not limited to the mentioned above, and other aspects not mentioned will be clearly understood by those skilled in the art from the following description.

According to an embodiment of the present inventive concept, a strain measuring device includes a first sensing optical fiber disposed on a surface of a measurement target. A second sensing optical fiber is spaced apart from the first sensing optical fiber and arranged parallel to the first sensing optical fiber. The second sensing optical fiber is spaced apart from the surface of the measurement target. An optical fiber guide has an inner cavity. The optical fiber guide is bonded to the surface of the measurement target to be positioned on the surface of the measurement target. The second sensing optical fiber is disposed in the inner cavity. A controller receives measured values from the first sensing optical fiber and the second sensing optical fiber. The first sensing optical fiber and the second sensing optical fiber include optical fibers for measuring strain.

According to an embodiment of the present inventive concept, a strain measuring device includes a first sensing optical fiber that is bonded to and integrated with a surface of a measurement target. A protective case is positioned parallel to the first sensing optical fiber. The protective case has a case cavity and an optical fiber hole. The optical fiber hole extends in a longitudinal direction of the first sensing optical fiber. The protective case is bonded to the surface of the measurement target. The first sensing optical fiber is disposed in the case cavity. A second sensing optical fiber is disposed in the optical fiber hole of the protective case and is arranged parallel to the first sensing optical fiber.

According to an embodiment of the present inventive concept, a strain measuring device includes a first sensing optical fiber disposed on a surface of a measurement target. The first sensing optical fiber is integrated with the surface of the measurement target by an adhesive. The first sensing optical fiber measures strain of the measurement target and strain due to temperature. A second sensing optical fiber is spaced apart from the first sensing optical fiber and arranged parallel to the first sensing optical fiber. The second sensing optical fiber is spaced apart from the surface of the measurement target. The second sensing optical fiber measures strain due to temperature. An optical fiber guide has an inner cavity. The optical fiber guide is bonded to the surface of the measurement target to be positioned on the surface of the measurement target. The second sensing optical fiber is disposed in the inner cavity. A protective case is bonded to the surface of the measurement target. The protective case covers a periphery of the first sensing optical fiber and the optical fiber guide. A controller receives measured values from the first sensing optical fiber and the second sensing optical fiber and calculates strain of the surface excluding strain due to temperature of the measurement target based on a difference between the measured values of the first sensing optical fiber and the measured values of the second sensing optical fiber. The first sensing optical fiber and the second sensing optical fiber are of a Brillouin optical correlation domain analysis (BOCDA) type. A distance between the second sensing optical fiber and the surface of the measurement target is greater than a distance between the first sensing optical fiber and the surface of the measurement target.

### BRIEF DESCRIPTION OF THE DRAWINGS

Embodiments will be more clearly understood from the following detailed description taken in conjunction with the accompanying drawings in which:

FIG. 1 is a cross-sectional view of a strain measuring device according to an embodiment of the present inventive concept;

FIG. 2 is a plan view of a strain measuring device taken along line A-A′ of FIG. 1 according to an embodiment of the present inventive concept;

FIG. 3 is a cross-sectional view of a strain measuring device according to an embodiment of the present inventive concept;

FIG. 4 is a cross-sectional view of a strain measuring device according to an embodiment of the present inventive concept;

FIG. 5 is a cross-sectional view of a strain measuring device according to an embodiment of the present inventive concept;

FIG. 6 is a cross-sectional view of a strain measuring device according to an embodiment of the present inventive concept;

FIG. 7 is a graph showing measurement results of sensing optical fibers of a strain measuring device according to an embodiment of the present inventive concept;

FIG. 8 is a graph showing strain calculation results of a strain measuring device according to an embodiment of the present inventive concept; and

FIG. 9 is a plan view of an embodiment to which a strain measuring device is applied according to an embodiment of the present inventive concept.

### DETAILED DESCRIPTION OF EMBODIMENTS

Hereinafter, embodiments of the present inventive concept will be described in detail with reference to the accompanying drawings. The same reference numerals are used for the same components in the drawings, and duplicate descriptions may be omitted for economy of description.

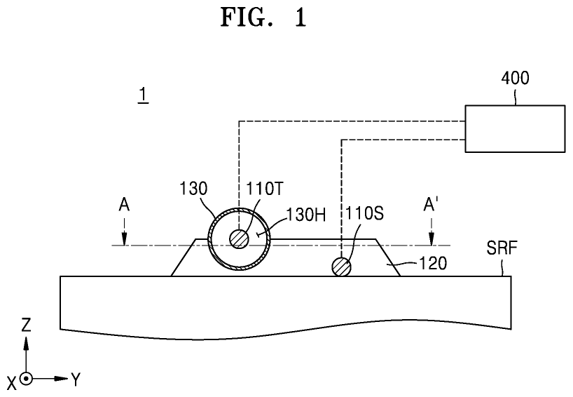

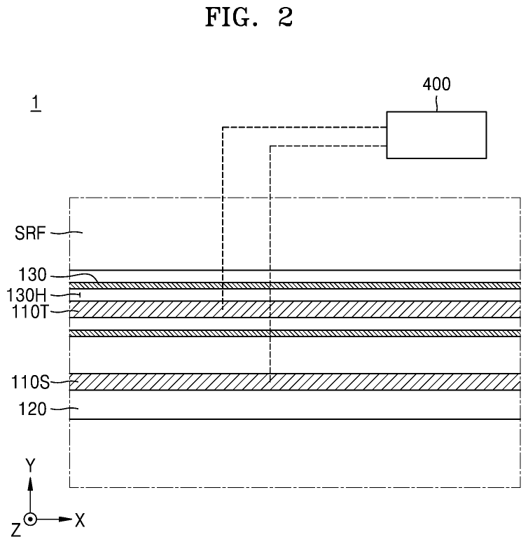

FIG. 1 is a cross-sectional view of a strain measuring device 1 according to an embodiment. FIG. 2 is a plan view of the strain measuring device 1 according to an embodiment by cutting a portion A-A′ in FIG. 1.

Referring to FIGS. 1 and 2, the strain measuring device 1 according to an embodiment may include a first sensing optical fiber 110S disposed on a measurement target surface SRF, an optical fiber guide 130 spaced apart from the first sensing optical fiber 110S and extending in the same direction as the longitudinal direction of the first sensing optical fiber 110S, a second sensing optical fiber 110T located in an inner cavity 130H provided in the optical fiber guide 130, an adhesive 120 that bonds the optical fiber guide 130 and the first sensing optical fiber 110S to the measurement target surface SRF for integration with the measurement target surface SRF, and a controller 400 connected to each end of the first sensing optical fiber 110S and the second sensing optical fiber 110T and calculating strain.

In an embodiment, the first sensing optical fiber 110S may be located adjacent to the measurement target surface SRF (e.g., in the Z direction) and be spaced apart from the measurement target surface SRF. Alternatively, a portion of a side surface of the first sensing optical fiber 110S may directly contact the measurement target surface SRF The first sensing optical fiber 110S may be integrated with the measurement target surface SRF. In an embodiment, the first sensing optical fiber 110S may be bonded to the measurement target surface SRF by the adhesive 120 so that a portion of a side surface of the first sensing optical fiber 110S directly contacts the measurement target surface SRF and the first sensing optical fiber 110S is integrated with the measurement target surface SRF. For example, the adhesive 120 may be composed of a material including epoxy.

In FIG. 1, the adhesive 120 is shown to completely cover the side surface of the first sensing optical fiber 110S. However, embodiments of the present inventive concept are not necessarily limited thereto and the application, arrangement and amount of the adhesive 120 may be adjusted as needed. Accordingly, within a range in which the first sensing optical fiber 110S is integrated with the measurement target surface SRF, more or less adhesive 120 may be applied than in FIG. 1. For example, the adhesive 120 may be applied to expose a portion of a side surface of the first sensing optical fiber 110S, such as an upper surface of the first sensing optical fiber 110S, etc.

The optical fiber guide 130 may be disposed on the measurement target surface SRF. As shown in FIG. 1, the optical fiber guide 130 may not directly contact the measurement target surface SRF. Alternatively, unlike an embodiment shown in FIG. 1, a portion of a side surface of the optical fiber guide 130 may directly contact the measurement target surface SRF. The optical fiber guide 130 may have an inner cavity 130H extending in the longitudinal direction of the optical fiber guide 130 therein (e.g., in the X direction).

The optical fiber guide 130 may be disposed on the measurement target surface SRF while being spaced apart from and arranged parallel to the first sensing optical fiber 110S. The optical fiber guide 130 may be integrated with the measurement target surface SRF. In an embodiment, the optical fiber guide 130 may be bonded to the measurement target surface SRF by the adhesive 120 so that the optical fiber guide 130 is integrated with the measurement target surface SRF. The optical fiber guide 130 may be bonded to the measurement target surface SRF by the adhesive 120 in a state in which the optical fiber guide 130 is spaced apart from the measurement target surface SRF or in which a portion of a side surface of the optical fiber guide 130 directly contacts the measurement target surface SRF.

In an embodiment, a cross-sectional view of the optical fiber guide 130 cut in a plane perpendicular to the longitudinal direction of the optical fiber guide 130 may have a circular shape as shown in FIG. 1. For example, the optical fiber guide 130 may have a tube shape. Alternatively, unlike in FIG. 1, the cross-sectional view of the optical fiber guide 130 cut in a plane perpendicular to the longitudinal direction of the optical fiber guide 130 may have a polygonal shape, such as a rectangular shape, etc. However, the cross-sectional view of the optical fiber guide 130 is not necessarily limited thereto and may vary.

The optical fiber guide 130 may have the inner cavity 130H in which the second sensing optical fiber 110T is disposed. The inner cavity 130H is dimensioned to be larger than the second sensing optical fiber 110T. Accordingly, the second sensing optical fiber 110T may be positioned to move relatively freely in the inner cavity 130H as compared to the first sensing optical fiber 110S which is integrated with the measurement target surface SRF. As shown in FIG. 1, a side surface of the second sensing optical fiber 110T may be positioned in the inner cavity 130H of the optical fiber guide 130 without directly contacting the optical fiber guide 130. Alternatively, unlike in FIG. 1, a side surface of the second sensing optical fiber 110T may be positioned in the inner cavity 130H of the optical fiber guide 130 and may be in direct contact with the optical fiber guide 130.

In an embodiment, the optical fiber guide 130 may be composed of a flexible material so that the strain measuring device 1 is efficiently installed on a flat or curved surface. For example, in an embodiment the optical fiber guide 130 may be composed of a material including stainless steel. Alternatively, the optical fiber guide 130 may be composed of a material including a polymer. However, the material of the optical fiber guide 130 is not necessarily limited thereto and may vary.

The optical fiber guide 130 may be bonded to the measurement target surface SRF by the adhesive 120. The side surface of the optical fiber guide 130 may be bonded to the measurement target surface SRF by the adhesive 120 while being in direct contact with or being spaced apart from the measurement target surface SRF.

As shown in FIG. 1, the optical fiber guide 130 and the first sensing optical fiber 110S may be bonded together to the measurement target surface SRF by the adhesive 120. Alternatively, unlike an embodiment shown in FIG. 1, the optical fiber guide 130 and the first sensing optical fiber 110S may be separately bonded to the measurement target surface SRF by the adhesive 120.

The optical fiber guide 130 having the second sensing optical fiber 110T disposed in the inner cavity 130H thereof may be bonded to the measurement target surface SRF by the adhesive 120 in a lateral direction of the first sensing optical fiber 110S previously installed alone on the measurement target surface SRF. For example, it is possible to utilize the optical fiber guide 130 in the strain measuring device 1 according to an embodiment by bonding the optical fiber guide 130 to the measurement target surface SRF by the adhesive 120 in the lateral direction of the first sensing optical fiber 110S previously installed alone on the measurement target surface SRF.

Since the second sensing optical fiber 110T is disposed in the inner cavity 130H of the optical fiber guide 130, the second sensing optical fiber 110T may be spaced apart from the measurement target surface SRF by a thickness greater than or equal to the thickness of the optical fiber guide 130 which defines the inner cavity 130H. A distance (e.g., a vertical distance in the Z direction) between the first sensing optical fiber 110S and the measurement target surface SRF may be zero or insignificant (e.g., relatively small) since the first sensing optical fiber 110S is integrated with the measurement target surface SRF or a portion of a side surface of the first sensing optical fiber 110S directly contacts the measurement target surface SRF. Accordingly, a distance between the second sensing optical fiber 110T and the measurement target surface SRF in the vertical direction (e.g., the Z direction) may be greater than a distance between the first sensing optical fiber 110S and the measurement target surface SRF in the vertical direction (e.g., the Z direction).

The controller 400 may be connected to the first sensing optical fiber 110S and the second sensing optical fiber 110T included in the strain measuring device 1 according to an embodiment. For example, each end of the first sensing optical fiber 110S and the second sensing optical fiber 110T may be connected to the controller 400 in a wired and/or wireless manner. As described below, the controller 400 is configured to receive the measured values from the first sensing optical fiber 110S and the second sensing optical fiber 110T to calculate the strain of the measurement target.

Since the first sensing optical fiber 110S is integrated with the measurement target surface SRF, the first sensing optical fiber 110S may directly measure the strain of the measurement target surface SRF. Since the second sensing optical fiber 110T is not integrated with the measurement target surface SRF and located in the inner cavity 130H of the optical fiber guide 130, the second sensing optical fiber 110T may not measure the strain of the measurement target surface SRF. However, since the second sensing optical fiber 110T is spaced apart from the first sensing optical fiber 110S while being positioned adjacent thereto on the measurement target surface SRF, the second sensing optical fiber 110T may measure the strain due to the external environment, such as temperature of the measurement target surface SRF and the ambient air.

For example, in an embodiment the second sensing optical fiber 110T may measure the strain due to the temperature of the inner cavity 130H affected by the temperature of the measurement target surface SRF and the ambient air, and the temperature of the optical fiber guide 130. For example, the optical fiber guide 130 may include metal so that the ambient temperature is easily transferred to the second sensing optical fiber 100T. For example, in an embodiment, the optical fiber guide 130 may be composed of a material including stainless steel. However, embodiments of the present inventive concept are not necessarily limited thereto.

In the present specification, the optical fiber may refer to an optical fiber sensor. Accordingly, the first sensing optical fiber 110S and the second sensing optical fiber 110T may be referred to a first sensing optical fiber sensor and a second sensing optical fiber sensor, respectively.

In an embodiment, the optical fiber sensors may be divided into a sensor using an optical fiber itself and a sensor receiving measurement results through an optical fiber. The sensor using an optical fiber itself may include a distribution-type sensor using backscattered light from an incident light source, which is a characteristic of optical fibers. The distribution-type sensor may include Rayleigh scattering-type, Raman scattering-type, and Brillouin scattering-type optical fiber sensors according to the type of the backscattered light. However, embodiments of the present inventive concept are not necessarily limited thereto.

In an embodiment, the first sensing optical fiber 110S and the second sensing optical fiber 110T of the strain measuring device 1 may be configured to be distribution-type sensors. For example, in an embodiment the first sensing optical fiber 110S and the second sensing optical fiber 110T of the strain measuring device 1 may be configured to be Brillouin scattering-type optical fiber sensors.

In the Brillouin scattering-type optical fiber sensor, the intrinsic Brillouin frequency value of the optical fiber may change depending on externally applied temperature or stress. For example, the Brillouin scattering-type optical fiber sensor is a sensor that measures a change in an external physical quantity based on a change in Brillouin frequency. For example, strain of the measurement target may be measured through the Brillouin scattering-type optical fiber sensor.

The distribution-type optical fiber sensors using Brillouin scattering may be of Brillouin optical time domain reflectometry (BORDR), Brillouin optical time domain analysis (BOTDA), and Brillouin optical correlation domain analysis (BOCDA) types. In an embodiment including the BOTDA type, long-range measurements are possible but spatial resolution may be limited. In embodiments having the BOCDA type, the spatial resolution is good but the measurement distance may be limited.

The first sensing optical fiber 110S and the second sensing optical fiber 110T may be distribution-type optical fiber sensors using Brillouin scattering. In an embodiment, the first sensing optical fiber 110S and the second sensing optical fiber 110T included in the strain measuring device 1 according to an embodiment may be BOCDA-type optical fiber sensors.

Ready-made sensing optical fibers may be used for the first sensing optical fiber 110S and the second sensing optical fiber 110T. In an embodiment, sensing optical fibers having a standardized diameter in a range of about 0.25 mm to about 1 mm may be used for the first sensing optical fiber 110S and the second sensing optical fiber 110T. For example, the first sensing optical fiber 110S and the second sensing optical fiber 110T may have a diameter of about 0.25 mm, and ready-made sensing optical fibers having a diameter of about 0.25 mm may be used for the first sensing optical fiber 110S and the second sensing optical fiber 110T. In an embodiment, optical fibers of the same type and standard may be used for the first sensing optical fiber 110S and the second sensing optical fiber 110T. Alternatively, optical fibers of different standards from each other may be used for the first sensing optical fiber 110S and the second sensing optical fiber 110T.

The first sensing optical fiber 110S and the second sensing optical fiber 110T are configured to sense strain at equal intervals on the first sensing optical fiber 110S and the second sensing optical fiber 110T or on the surface of the measurement target. The first sensing optical fiber 110S and the second sensing optical fiber 110T may sense strain at equal intervals to each other. For example, the first sensing optical fiber 110S and the second sensing optical fiber 110T are each configured to measure strain at equal intervals in a range of about 1 cm to about 5 cm, respectively. In an embodiment, the first sensing optical fiber 110S and the second sensing optical fiber 110T of the strain measuring device 1 according to an embodiment may be configured to measure strain of the measurement target at equal intervals of about 2 cm.

As shown in FIG. 2, the first sensing optical fiber 110S may be positioned parallel to the second sensing optical fiber 110T. The optical fiber guide 130 having the second sensing optical fiber 110T in the inner cavity 130H may be positioned parallel to the first sensing optical fiber 110S.

In the strain measuring device 1 according to an embodiment, since the first sensing optical fiber 110S is adjacent to the measurement target surface SRF or is integrated with the measurement target surface SRF while a portion of a side surface of the first sensing optical fiber 110S is in contact with the measurement target surface SRF, the first sensing optical fiber 110S may acquire measured values of strain including strain due to a temperature of the measurement target.

The second sensing optical fiber 110T may obtain measured values of strain with respect to the temperature of the measurement target and the ambient air since the second sensing optical fiber 110T is positioned adjacent to the first sensing optical fiber 110S and is provided in the inner cavity 130H of the optical fiber guide 130.

The controller 400 may receive the measured values of the first sensing optical fiber 110S and the second sensing optical fiber 110T. Based on the difference between the measured values of the first sensing optical fiber 110S and the measured values of the second sensing optical fiber 110T, the controller 400 may calculate the pure strain which excludes the strain due to the temperature of the measurement target. A specific strain calculation method is described below. Therefore, it is possible to measure the pure strain, such as strain due to aging and fatigue of the measurement target which excludes strain due to the temperature of the ambient air. For example, the strain measuring device 1 according to an embodiment may calculate the strain excluding strain due to the temperature of the measurement target.

The controller 400 may periodically receive measured values from the first sensing optical fiber 110S and the second sensing optical fiber 110T. The controller 400 may calculate the strain of the measurement target based on the measured values periodically received from the first sensing optical fiber 110S and the second sensing optical fiber 110T. While tracking changes in data values of strain values of the measurement target, it is possible to determine whether or not the strain of the measurement target is abnormal through the strain data measured by the controller 400. Through the strain measuring device 1 according to an embodiment, it is possible to continuously detect and track the strain values of the measurement target without requiring cost and time consumption for separate strain measurements of the measurement target.

The strain measuring device 1 according to an embodiment may measure the strain of various objects. In an embodiment, the strain measuring device 1 may be used to measure the strain of a relatively large liquid tank in which liquid is stored.

In the relatively large liquid tank, relatively greater stress may be applied to a lower portion of the relatively large liquid tank than to an upper portion thereof due to the pressure of the fluid stored in the liquid tank. When the relatively large liquid tank is located outdoors, the relatively large liquid tank may expand or contract due to temperature. In addition, when the relatively large liquid tank is located outdoors, the temperature of a portion of the relatively large liquid tank exposed to the sun may be relatively higher than that of the other portions not exposed to the sun.

The strain measuring device 1 according to an embodiment may measure the strain of the measurement target from which the strain due to such temperature is removed By installing the strain measuring device 1 around the relatively large liquid tank, it is possible to measure the strain of the relatively large liquid tank excluding temperature change.

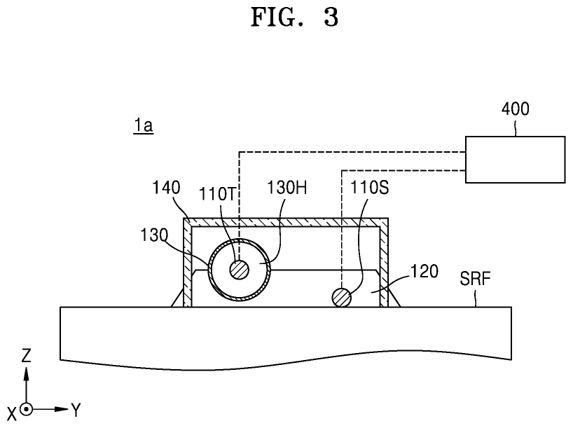

FIG. 3 is a cross-sectional view of a strain measuring device 1a according to an embodiment. The description of elements that are identical or similar as the previous description is omitted for economy of description.

Referring to FIG. 3, the strain measuring device 1a according to an embodiment may further include a protective case 140. The protective case 140 may directly contact the measurement target surface SRF. Alternatively, unlike an embodiment shown in FIG. 3, the protective case 140 may be bonded to the measurement target surface SRF while being spaced apart from the measurement target surface SRF with the adhesive 120 therebetween. In an embodiment in which the optical fiber guide 130 and the first sensing optical fiber 110S are bonded to the measurement target surface SRF by the adhesive 120, the protective case 140 may also be bonded to the measurement target surface SRF together.

The protective case 140 may cover the first sensing optical fiber 110S and the optical fiber guide 130. For example, the protective case 140 may cover a periphery of the first sensing optical fiber 110S. The protective case 140 may cover the first sensing optical fiber 110S and the optical fiber guide 130 so that the first sensing optical fiber 110S and the optical fiber guide 130 are not exposed to the outside. The first sensing optical fiber 110S and the optical fiber guide 130 may be separated from the outside by the protective case 140 and the measurement target surface SRF. Accordingly, in the strain measuring device 1a according to an embodiment, the first sensing optical fiber 110S and the second sensing optical fiber 110T may be protected from the outside by the optical fiber guide 130 and the protective case 140. For example, in the strain measuring device 1a according to an embodiment, the first sensing optical fiber 110S and the second sensing optical fiber 110T may be protected from external heat and impact by the optical fiber guide 130 and the protective case 140.

A cross-sectional view of the protective case 140 cut by a plane perpendicular to the longitudinal direction of the protective case 140 may have a horseshoe shape. In an embodiment, the protective case 140 may have an angled horseshoe-shaped cross-section or a rectangular cross-section. However, embodiments of the present inventive concept are not necessarily limited thereto and the cross-section shape of the protective case 140 may vary. An open portion of the protective case 140 may face the measurement target surface SRF.

In an embodiment, the protective case 140 may be composed of a flexible material. The strain measuring device 1a according to an embodiment may be installed even when the measurement target surface SRF has a curved surface rather than a flat surface. In an embodiment, the protective case 140 may be composed of a material including metal or polymer. For example, the protective case 140 may be composed of a material including stainless steel.

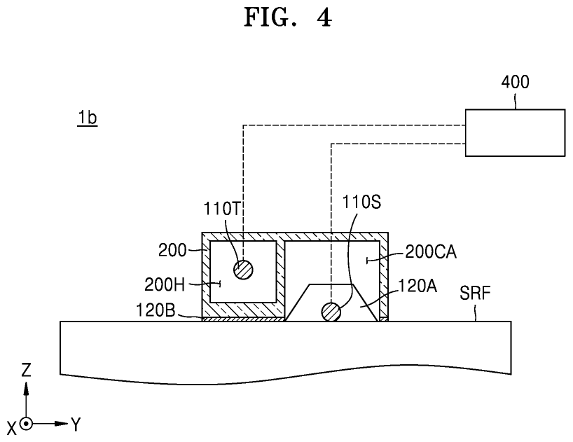

FIG. 4 is a cross-sectional view of a strain measuring device 1b according to an embodiment. The description of elements that are identical or similar as the previous description may be omitted for economy of description.

Referring to FIG. 4, the strain measuring device 1b may include a protective case 200 having an optical fiber hole 200H in which the second sensing optical fiber 110T is disposed therein and a case cavity 200CA in which the first sensing optical fiber 110S is disposed.

As described above, the first sensing optical fiber 110S may be positioned adjacent to the measurement target surface SRF and be spaced apart therefrom. Alternatively, a portion of a side surface of the first sensing optical fiber 110S may directly contact the measurement target surface SRF. The first sensing optical fiber 110S may be integrated with the measurement target surface SRF. In an embodiment, the first sensing optical fiber 110S may be bonded to the measurement target surface SRF by an adhesive 120A so that the portion of the side surface of the first sensing optical fiber 110S contacts the measurement target surface SRF and the first sensing optical fiber 110S is integrated with the measurement target surface SRF. For example, the adhesive 120A may be composed of a material including epoxy.

In an embodiment as shown in FIG. 4, the adhesive 120A is shown to cover all sides of the first sensing optical fiber 110S except for portions directly contacting the measurement target surface SRG. However, embodiments of the present inventive concept are not necessarily limited thereto and the application and amount of the adhesive 120A may be adjusted as needed. Accordingly, within a range in which the first sensing optical fiber 110S is integrated with the measurement target surface SRF, more or less adhesive 120A may be applied than in FIG. 4. For example, the adhesive 120A may be applied to expose a portion of a side surface of the first sensing optical fiber 110S, such as an upper side surface, etc.

One side of the protective case 200 may extend to cover the first sensing optical fiber 110S. A space provided so that one side of the protective case 200 extends to cover the first sensing optical fiber 110S is referred to as a case cavity 200CA. The case cavity 200CA may be provided in the longitudinal direction of the protective case 200, and the first sensing optical fiber 110S may be provided in the case cavity 200CA.

The protective case 200 may have an optical fiber hole 200H having the second sensing optical fiber 110T disposed therein. Since the role of the optical fiber hole 200H is substantially the same as that of the inner cavity 130H described with reference to FIGS. 1 to 3, the optical fiber hole 200H may be referred to as an inner cavity and a repeated description will be omitted for economy of description.

In an embodiment, the optical fiber hole 200H may have a polygonal shape based on a cut surface perpendicular to the longitudinal direction of the protective case 200. As shown in FIG. 4, in an embodiment the optical fiber hole 200H may have a rectangular shape based on a cut surface perpendicular to the longitudinal direction of the protective case 200. Alternatively, unlike an embodiment shown in FIG. 4, the optical fiber hole 200H may have a circular shape. However, embodiments of the present inventive concept are not necessarily limited thereto and the shape of the optical fiber hole 200H may vary.

The second sensing optical fiber 110T may be spaced apart from the measurement target surface SRF by the protective case 200 and the optical fiber hole 200H. Since the second sensing optical fiber 110T is provided in the optical fiber hole 200H and is not integrated with the measurement target surface SRF, the second sensing optical fiber 110T may measure the strain with respect to the temperature of the measurement target surface SRF and the ambient air.

In an embodiment, the protective case 200 may be bonded to the measurement target surface SRF by an adhesive 120B. The protective case 200 may be composed of a flexible material for efficient installation of the strain measuring device 1b on a flat or curved surface. In an embodiment, the protective case 200 may be composed of a material including stainless steel. Alternatively, the protective case 200 may be composed of a material including polymer. However, the material of the protective case 200 is not necessarily limited thereto and the material may vary.

In the strain measuring device 1b according to an embodiment, the first sensing optical fiber 110S is integrated with the measurement target surface SRF, and the second sensing optical fiber 110T is not integrated with the measurement target surface SRF. Therefore, the strain measuring device 1b according to an embodiment may measure the strain excluding strain due to the temperature of the measurement target. In addition, the first sensing optical fiber 110S and the second sensing optical fiber 110T may be protected from the outside by the protective case 200.

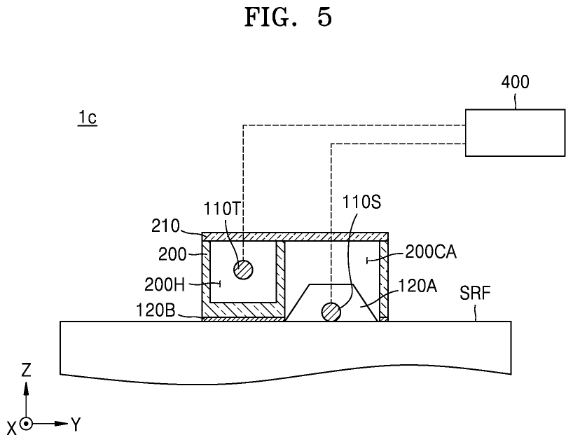

FIG. 5 is a cross-sectional view of a strain measuring device Ic according to an embodiment.

Referring to FIG. 5, the protective case 200 may include a protective cover 210. In an embodiment, the protective cover 210 may be opened or closed from the protective case 200. For example, the protective cover 210 may be detachable from the protective case 200 (e.g., able to be removed and reattached). When the protective cover 210 is removed, the first sensing optical fiber 110S and the second sensing optical fiber 110T may be exposed. Alternatively, when the protective cover 210 is removed, only one of the first sensing optical fiber 110S and the second sensing optical fiber 110T may be configured to be exposed. For example, the first sensing optical fiber 110S and the second sensing optical fiber 110T may be simultaneously exposed by the protective cover 210, or the first sensing optical fiber 110S or the second sensing optical fiber 110T may be selectively exposed by the protective cover 210. In the strain measuring device 1c according to an embodiment, maintenance and repair of the first sensing optical fiber 110S and the second sensing optical fiber 110T may be efficiently performed through opening and closing of the protective cover 210.

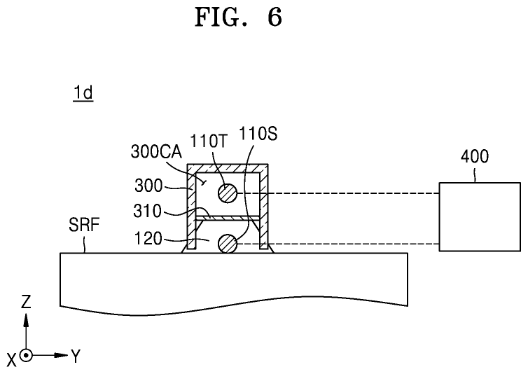

FIG. 6 is a cross-sectional view of a strain measuring device 1d according to an embodiment.

Referring to FIG. 6, the strain measuring device 1d may include a first sensing optical fiber 110S, a second sensing optical fiber 110T spaced apart from the first sensing optical fiber 110S and positioned parallel to the first sensing optical fiber 110S so that the second sensing optical fiber 110T overlaps the first sensing optical fiber 110S in the vertical direction (e.g., the Z direction), a protective case 300 that surrounds the first sensing optical fiber 110S and the second sensing optical fiber 110T and includes an inner cavity 300CA in which the second sensing optical fiber 110T is provided, and a controller 400.

The protective case 300 may cover the first sensing optical fiber 110S and the second sensing optical fiber 110T that are parallel and spaced apart from each other in a vertical direction. Since one side of the protective case 300 is open and has no wall, the first sensing optical fiber 110S bonded to the measurement target surface SRF may be provided in the protective case 300. Two facing sidewalls of the protective case 300 may extend toward the measurement target surface SRF, and the two sidewalls may be bonded to the measurement target surface SRF by the adhesive 120. The two sidewalls may directly contact the measurement target surface SRF or may be spaced apart from the measurement target surface SRF by a relatively small distance.

The protective case 300 may further include an optical fiber barrier 310 provided between the first sensing optical fiber 110S and the second sensing optical fiber 110T. The second sensing optical fiber 110T may be spaced apart from the first sensing optical fiber 110S in a vertical direction (Z-axis direction) by the optical fiber barrier 310.

As described above, the adhesive 120 bonds the first sensing optical fiber 110S to the measurement target surface SRF. The adhesive 120 may also bond the optical fiber barrier 310 and the protective case 300 to the measurement target surface SRF. In an embodiment, the adhesive 120 may be composed of a material including epoxy.

As described above, in the strain measuring device 1d according to an embodiment, since the first sensing optical fiber 110S is adjacent to the measurement target surface SRF or is integrated with the measurement target surface SRF while a portion of a side surface of the first sensing optical fiber 110S is in contact with the measurement target surface SRF, the first sensing optical fiber 110S may acquire measured values of strain including strain due to the temperature of the measurement target.

Since the second sensing optical fiber 110T is positioned adjacent to the first sensing optical fiber 110S (e.g., in the Z direction) and is provided in the inner cavity 300CA of the protective case 300, the second sensing optical fiber 110T may obtain the measured values of the strain with respect to the temperature of the measurement target and the ambient air.

Based on the difference between the measured values of the first sensing optical fiber 110S and the measured values of the second sensing optical fiber 110T, the strain measuring device 1d according to an embodiment may measure the strain (e.g., pure strain) which excludes strain due to the temperature of the measurement target. In addition, the first sensing optical fiber 110S and the second sensing optical fiber 110T may be protected from the outside by the protective case 300.

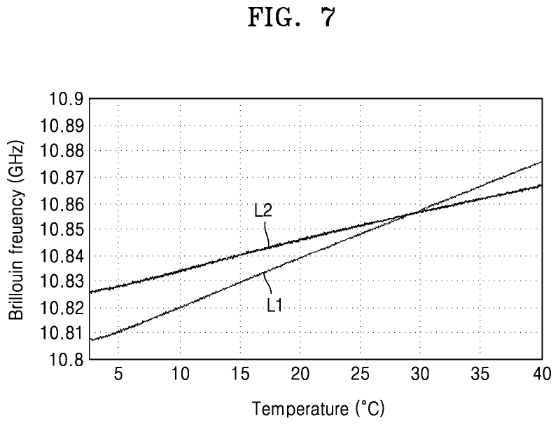

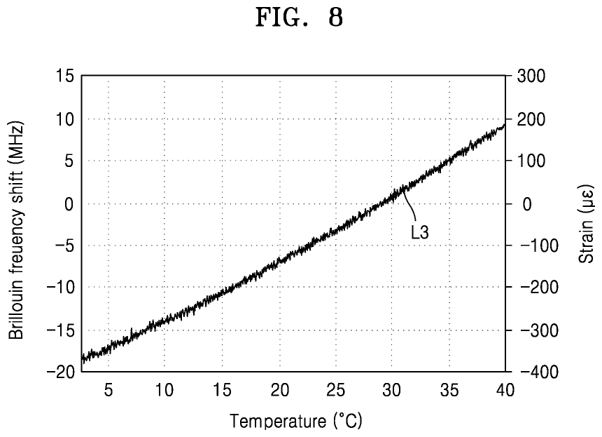

FIG. 7 is a graph showing measurement results of sensing optical fibers of a strain measuring device according to an embodiment. FIG. 8 is a graph showing strain calculation results of a strain measuring device according to an embodiment.

Referring to FIGS. 7 and 8, the measured values obtained from the first sensing optical fiber 110S are denoted by a first line L1, the measured values obtained from the second sensing optical fiber 110T are denoted by a second line L2, and differences between the measured values of the first sensing optical fiber 110S and the second sensing optical fiber 110T are denoted by a third line L3 shown in FIG. 8. In the graph of FIG. 7, the horizontal axis represents the temperature in degrees Celsius, and the vertical axis represents the Brillouin frequency in GHz.

Since the first line L1 is values measured from the first sensing optical fiber 110S, it is a result graph of measured values including pure strain of the measurement target and strain due to temperature. Since the second line L2 is values measured from the second sensing optical fiber 110T, it is a result graph of measured values including strain due to temperature.

In the graph of FIG. 8, the horizontal axis represents the temperature in degrees Celsius, and the left vertical axis represents the Brillouin frequency shift representing the difference in Brillouin frequency in MHz. The graph of FIG. 8 shows the third line L3 obtained by subtracting the values of the second line L2 from the values of the first line L1 for the same temperature.

The values obtained by subtracting the values of the second line L2 from the values of the first line L1 which are the Brillouin frequency shift shown in the left vertical axis may be converted into the strain of the measurement target by multiplying the Brillouin frequency shift values each by the conversion factor. In an embodiment, when the Brillouin frequency shift values are divided by conversion factor corresponding to 0.05 MHz/micro-strain, the Brillouin frequency shift values may be converted into strain indicated on the right vertical axis.

The strain values indicated by the third line L3 in FIG. 8 are the strain values obtained by removing the strain due to temperature and thus refer to the pure strain of the measurement target. Therefore, it is possible to measure the pure strain of the measurement target by the strain measuring devices 1, 1a, 1b, 1c, and 1d according to embodiments.

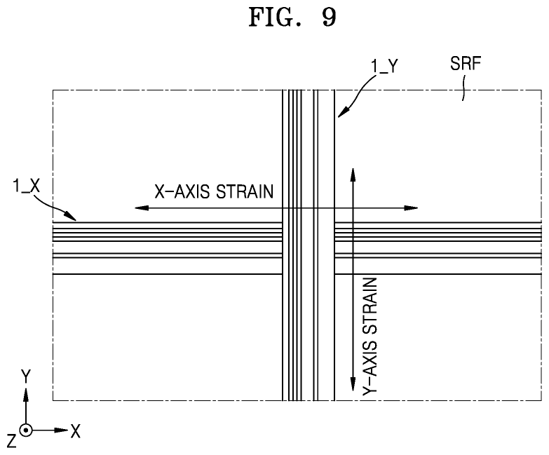

FIG. 9 is a plan view of an embodiment to which a strain measuring device 1 according to an embodiment is applied.

Referring to FIG. 9, the strain measuring device 1 according to an embodiment may be installed on the measurement target surface SRF in a grid form. For example, a transverse strain measuring device 1_X may be arranged to extend in the same direction as the X-axis direction on the drawing. For example, a longitudinal strain measuring device 1_Y may be arranged to extend in the same direction as the Y-axis direction in the drawing. In an embodiment, the transverse and longitudinal strain measuring devices may be installed on the measurement target surface SRF so as to be perpendicular to each other. Through the strain measuring device in a grid form, strains in two directions of measurement targets in two directions may be measured together. It is possible to determine the cause of the strain of the measurement target by measuring in which direction the strain of the measurement target occurs through the strain measuring device.

While the present inventive concept has been particularly shown and described with reference to non-limiting embodiments thereof, it will be understood that various changes in form and details may be made therein without departing from the spirit and scope of the present inventive concept.

What is claimed is:

1. A strain measuring device comprising:
a first sensing optical fiber disposed on a surface of a measurement target;
a second sensing optical fiber spaced apart from the first sensing optical fiber and arranged parallel to the first sensing optical fiber, the second sensing optical fiber is spaced apart from the surface of the measurement target;
an optical fiber guide having an inner cavity, the optical fiber guide is bonded to the surface of the measurement target to be positioned on the surface of the measurement target, wherein the second sensing optical fiber is disposed in the inner cavity; and
a controller receiving measured values from the first sensing optical fiber and the second sensing optical fiber;
wherein the first sensing optical fiber and the second sensing optical fiber include optical fibers for measuring strain.

2. The strain measuring device of claim 1, wherein:
the first sensing optical fiber measures strain of the measurement target and strain due to temperature; and
the second sensing optical fiber measures the strain due to temperature and does not measure the strain of the measurement target.

3. The strain measuring device of claim 2, wherein the controller calculates a strain of the surface excluding the strain due to the temperature of the measurement target based on a difference between the measured values of the first sensing optical fiber and the measured values of the second sensing optical fiber.

4. The strain measuring device of claim 3, wherein the first sensing optical fiber is integrated with the surface of the measurement target.

5. The strain measuring device of claim 4, wherein:
a portion of a side surface of the first sensing optical fiber is in direct contact with the surface of the measurement target; and
the first sensing optical fiber is integrated with the surface of the measurement target by an adhesive.

6. The strain measuring device of claim 5, wherein the adhesive includes epoxy.

7. The strain measuring device of claim 1, wherein the first sensing optical fiber and the second sensing optical fiber are of a Brillouin optical correlation domain analysis (BOCDA) type.

8. The strain measuring device of claim 1, wherein the strain measuring device includes a protective case,
wherein the protective case covers a periphery of the first sensing optical fiber and the optical fiber guide, the protective case is bonded to the surface of the measurement target.

9. The strain measuring device of claim 1, wherein the first sensing optical fiber and the second sensing optical fiber measure the strain of the measurement target at equal intervals.

10. The strain measuring device of claim 9, wherein the equal intervals are in a range of about 1 cm to about 5 cm.

11. The strain measuring device of claim 1, wherein a cross-section of the inner cavity has a rectangular or circular shape based on a cut plane perpendicular to a longitudinal direction of the first sensing optical fiber or the second sensing optical fiber.

12. The strain measuring device of claim 1, wherein:
the second sensing optical fiber is spaced apart from the surface of the measurement target; and
the first sensing optical fiber is positioned between the second sensing optical fiber and the surface of the measurement target in a vertical direction.

13. The strain measuring device of claim 12, wherein two parallel sidewalls of the optical fiber guide extend to surround side surfaces of the first sensing optical fiber, wherein the two parallel sidewalls are bonded to the surface of the measurement target.

14. The strain measuring device of claim 1, wherein a distance between the second sensing optical fiber and the surface of the measurement target is greater than a distance between the first sensing optical fiber and the surface of the measurement target.

15. A strain measuring device comprising:
a first sensing optical fiber that is bonded to and integrated with a surface of a measurement target;
a protective case positioned parallel to the first sensing optical fiber, the protective case having a case cavity and an optical fiber hole, the optical fiber hole extending in a longitudinal direction of the first sensing optical fiber, the protective case is bonded to the surface of the measurement target, wherein the first sensing optical fiber is disposed in the case cavity; and
a second sensing optical fiber is disposed in the optical fiber hole of the protective case and arranged parallel to the first sensing optical fiber.

16. The strain measuring device of claim 15,
wherein a distance between the first sensing optical fiber and the surface of the measurement target in a vertical direction is less than a distance between the second sensing optical fiber and the surface of the measurement target in the vertical direction.

17. The strain measuring device of claim 15, further comprising a controller calculating the strain of the measurement target based on values measured from the first sensing optical fiber and the second sensing optical fiber.

18. The strain measuring device of claim 15, wherein:
the protective case further comprises a detachable protective cover, and
when the protective cover is removed from the protective case, the first sensing optical fiber or the second sensing optical fiber is selectively exposed or the first sensing optical fiber and the second sensing optical fiber are simultaneously exposed.

19. The strain measuring device of claim 15, wherein:
the protective case is bonded to the surface of the measurement target by an adhesive; and
the protective case is composed of a material including stainless steel.

20. A strain measuring device comprising:
a first sensing optical fiber disposed on a surface of a measurement target, the first sensing optical fiber is integrated with the surface of the measurement target by an adhesive, the first sensing optical fiber measures strain of the measurement target and strain due to temperature;
a second sensing optical fiber spaced apart from the first sensing optical fiber and arranged parallel to the first sensing optical fiber, the second sensing optical fiber is spaced apart from the surface of the measurement target, the second sensing optical fiber measures strain due to temperature;
an optical fiber guide having an inner cavity, the optical fiber guide is bonded to the surface of the measurement target to be positioned on the surface of the measurement target, wherein the second sensing optical fiber is disposed in the inner cavity;
a protective case bonded to the surface of the measurement target, the protective case covering a periphery of the first sensing optical fiber and the optical fiber guide; and
a controller receiving measured values from the first sensing optical fiber and the second sensing optical fiber and calculating strain of the surface excluding strain due to temperature of the measurement target based on a difference between the measured values of the first sensing optical fiber and the measured values of the second sensing optical fiber;
wherein the first sensing optical fiber and the second sensing optical fiber are of a Brillouin optical correlation domain analysis (BOCDA) type, and a distance between the second sensing optical fiber and the surface of the measurement target is greater than a distance between the first sensing optical fiber and the surface of the measurement target.
